(19) United States
(12) Patent Application Publication
(10) Pub. No.: US 2025/0197149 A1
(43) Pub. Date: Jun. 19, 2025

(54) ROLL TRANSFER DEVICE AND METHOD

(71) Applicant: SEMES CO., LTD., Chungcheongnam-do (KR)

(72) Inventors: Hong Woon SEO, Gyeonggi-do (KR); Seon Jung KIM, Chungcheongnam-do (KR)

(21) Appl. No.: 18/984,747

(22) Filed: Dec. 17, 2024

(30) Foreign Application Priority Data
Dec. 18, 2023 (KR) 10-2023-0184819

(51) Int. Cl. B65H 19/12; B65H 26/00; H01M 10/04

(52) U.S. Cl. CPC B65H 19/126; B65H 26/00; H01M 10/0409; B65H 2301/41346; B65H 2301/41829; B65H 2403/90; B65H 2553/43

(57) ABSTRACT

A roll transfer device and method is provided, which makes it easy to recognize a unique identification code for a material wound on a roll while quickly and accurately aligning a position of the roll. The roll transfer device comprises a pair of holding units disposed to be spaced apart from each other in a first direction, supporting a roll core seated thereon; and a pair of rotation units disposed on both sides of the roll core along the first direction, wherein the pair of rotation units linearly move in the first direction and are inserted into the roll core seated on the holding unit to align a position of the roll, include one or more keys coupled to one or more key grooves formed in the roll core, and are rotated in a state that they are inserted into the roll core, so that the key is coupled to the key groove, thereby rotating the roll.

### CROSS-REFERENCE TO RELATED APPLICATION

This application claims priority from Korean Patent Application No. 10-2023-0184819 filed on Dec. 18, 2023, in the Korean Intellectual Property Office and all the benefits accruing therefrom under 35 U.S.C. 119, the contents of which in its entirety are herein incorporated by reference.

### BACKGROUND

### Technical Field

The present disclosure relates to a roll transfer device and method.

### Description of the Related Art

Secondary batteries are batteries that can be used repeatedly through discharging that converts chemical energy into electrical energy and charging that converts electrical energy into chemical energy.

Examples of the secondary batteries include nickel-cadmium batteries, nickel-hydrogen batteries, lithium-ion batteries, or lithium-ion polymer batteries.

This secondary battery includes a cathode, an anode, an electrolyte and a separator, and stores and generates electricity by using a voltage difference between different cathode and anode materials.

Among methods of manufacturing a secondary battery, a method of manufacturing a lithium ion secondary battery includes stacking a first separator, an anode plate, a second separator and an anode plate, winding them multiple times to form an electrode assembly, sealing the electrode assembly in a case and injecting an electrolyte into the case.

In this case, the separator is provided and supplied in the form of a wound roll, and such a separator cannot increase a diameter due to material characteristics, whereby the roll should be frequently replaced in a winding process.

In this way, in order to replace the roll, when the roll wound with the separator is stocked, a worker classifies the roll depending on the type of the corresponding separator, and supplies the classified roll to a manufacturing device.

Meanwhile, a position and centering of the roll mounted on the manufacturing device should be accurately recognized so that a defect rate of a product may be reduced. However, the worker controls the position and centering of the roll while directly checking them, resulting in inconvenience and a lot of work time, and productivity is deteriorated because the manufacturing device should be stopped during the corresponding work.

In addition, since the roll cannot be always stocked in place, it was difficult to recognize a unique identification code for a material wound on the roll.

### BRIEF SUMMARY

An object of the present disclosure is to provide a roll transfer device and method that makes it easy to recognize a unique identification code for a material wound on a roll while quickly and accurately aligning a position of the roll.

The objects of the present disclosure are not limited to those mentioned above and additional objects of the present disclosure, which are not mentioned herein, will be clearly understood by those skilled in the art from the following description of the present disclosure.

A roll transfer device according to one aspect of the present disclosure devised to achieve the above object comprises a pair of holding units disposed to be spaced apart from each other in a first direction, supporting a roll core seated thereon; and a pair of rotation units disposed on both sides of the roll core along the first direction, wherein the pair of rotation units linearly move in the first direction and are inserted into the roll core seated on the holding unit to align a position of the roll, include one or more keys coupled to one or more key grooves formed in the roll core, and are rotated in a state that they are inserted into the roll core, so that the key is coupled to the key groove, thereby rotating the roll.

A roll transfer device according to another aspect of the present disclosure devised to achieve the above object comprises a pair of holding units disposed to be spaced apart from each other in a first direction, supporting a roll core seated thereon; and a pair of rotation units disposed on both sides of the roll core along the first direction, wherein the rotation unit includes a rod extended in the first direction toward the roll core, a pad provided on one side of the rod toward the roll core, including a key coupled to a key groove formed in the roll core, a first driving member provided to linearly move the rod in the first direction, and a second driving member provided to rotate the rod.

A roll transfer method according to one aspect of the present disclosure devised to achieve the above object comprises seating a roll core on a pair of holding units at a position between the pair of holding units spaced apart from each other in a first direction to face each other by an unmanned transport vehicle or a forklift; aligning a position of the roll along the first direction by the pair of rotation units disposed on both sides of the roll core; coupling one or more keys provided in the pair of rotation units to one or more key grooves formed in the roll core by rotating the pair of rotation units in a state that the rotation units are inserted into the roll core, and thus rotating the roll together with the pair of rotation units; recognizing a unique identification number for a material wound on the roll by a barcode reader; and transferring the roll to a stacker crane by moving the pair of holding units in a second direction.

Details of the other embodiments are included in the detailed description and drawings.

In the roll transfer device and method according to some embodiments of the present disclosure, the unique identification code for the wound material may be easily recognized while the position of the roll is aligned quickly and accurately through the rotation unit, so that productivity may be improved and time and manpower required to align the position of the roll and recognize the unique identification code may be shortened.

The effects according to the embodiment of the present disclosure are not limited to those mentioned above, and more various effects are included in the following description of the present disclosure.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a schematic perspective view illustrating a roll of a roll transfer device according to some embodiments of the present disclosure;

FIG. 2 is a schematic perspective view illustrating a roll transfer device according to some embodiments of the present disclosure;

FIG. 3 is a schematic cross-sectional view illustrating a roll transfer device according to some embodiments of the present disclosure;

FIG. 4 is a schematic partial perspective view illustrating a roll transfer device according to some embodiments of the present disclosure;

FIG. 5 is a schematic partial perspective view illustrating a rotation unit of a roll transfer device according to some embodiments of the present disclosure;

FIG. 6 is a flow chart illustrating a roll transfer method according to some embodiments of the present disclosure;

FIG. 7 is a schematic perspective view illustrating a state that a roll core is seated on a holding unit of a roll transfer device to describe a roll transfer method according to some embodiments of the present disclosure; and

FIG. 8 is a schematic cross-sectional view illustrating a state that a roll core is seated on a holding unit of a roll transfer device to describe a roll transfer method according to some embodiments of the present disclosure.

### DETAILED DESCRIPTION OF THE DISCLOSURE

Hereinafter, the preferred embodiment of the present disclosure will be described in detail with reference to the accompanying drawings. Advantages and features of the present disclosure and methods of achieving the advantages and features will be apparent from the following embodiments that will be described in more detail with reference to the accompanying drawings. It should be noted, however, that the present disclosure is not limited to the following embodiments, and may be implemented in various forms. The embodiments are provided only to disclose the present disclosure and let those skilled in the art understand the scope of the present disclosure. In the drawings, the embodiments of the present disclosure are defined by the scope of claims. The same reference numerals denote the same elements throughout the specification.

The terms used herein are for the purpose of embodiments, and are not intended to be limit the present disclosure. In the present disclosure, unless referred to the contrary, the singular forms are intended to include the plural forms. The terms “comprises” and/or “comprising” used herein specify the presence of stated elements, steps, operations and/or targets but do not preclude the presence or addition of one or more other elements, steps, operations and/or targets.

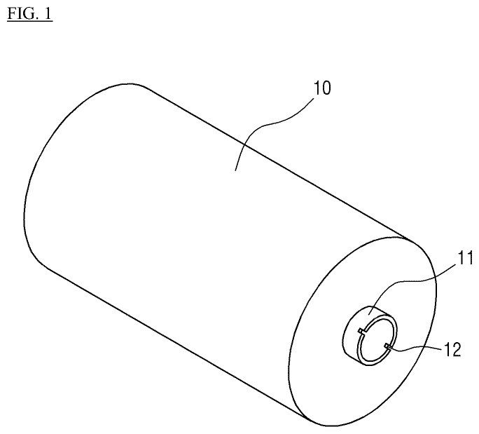

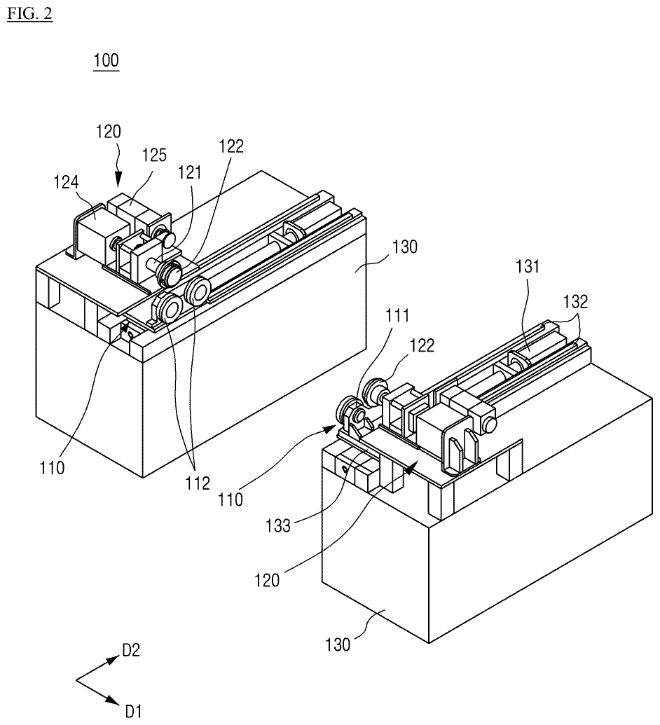

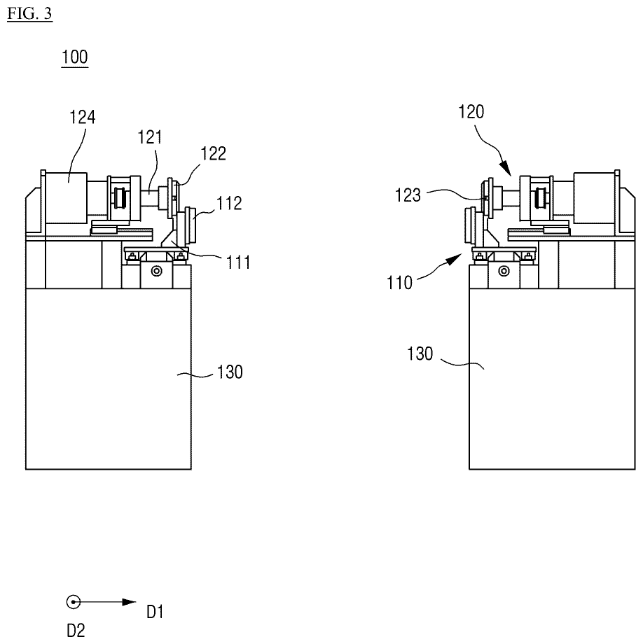

FIG. 1 is a schematic perspective view illustrating a roll of a roll transfer device according to some embodiments of the present disclosure. FIG. 2 is a schematic perspective view illustrating a roll transfer device according to some embodiments of the present disclosure. FIG. 3 is a schematic cross-sectional view illustrating a roll transfer device according to some embodiments of the present disclosure.

Referring to FIGS. 1 to 3, a roll transfer device 100 according to some embodiments of the present disclosure includes a holding unit 110 and a rotation unit 120.

The holding unit 110 may be provided in pairs spaced apart from each other in a first direction D1. In this case, the first direction D1 may be a left-right direction based on FIG. 3.

The holding unit 110 may support a roll core 11 seated thereon.

The holding unit 110 may include a support panel 111, a holding roller 112, a driving means and a detection sensor.

The support panel 111 may be disposed on a worktable 130. The support panel 111 may move along a second direction D2 while being disposed on the worktable 130. In this case, the second direction D2 may be a direction orthogonal to the first direction D1 on a plane based on FIG. 2.

A holding roller 112 may be disposed on the support panel 111.

The holding roller 112 may be disposed on the support panel 111. The holding roller 112 may be disposed to be rotatable. The holding roller 112 may be disposed in pairs to rotatably support the roll core 11.

In other words, a pair of holding rollers 112 are rotatably disposed on the support panel 111 to support the rotation of the roll core 11 seated on the pair of holding rollers 112.

The driving means is provided to rotate the pair of holding rollers 112. The driving means may have a shape of a motor. The driving means may be connected to a controller. The driving means may be actuated by the controller to rotate the pair of holding rollers 112.

The detection sensor may detect the seating of the roll core 11. That is, the detection sensor may detect that the roll core 11 of the roll 10, which is carried in the roll transfer device 100 by an automatic guided vehicle (AGV) or a forklift, is seated on the pair of holding rollers 112. The detection sensor may transfer a signal, which has detected that the roll core 11 is seated, to the controller.

The detection sensor may be disposed on the support panel 111 or the holding roller 112.

The holding unit 110 may move along the second direction D2 on the worktable 130. Therefore, the roll 10 in which a unique identification number for a wound material is recognized may be transferred to a stacker crane.

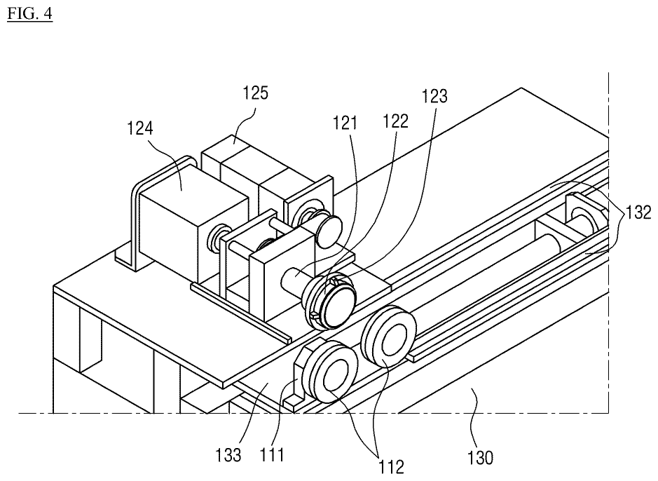

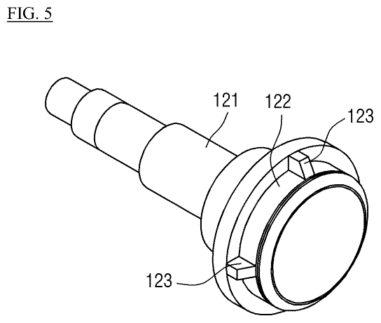

FIG. 4 is a schematic partial perspective view illustrating a roll transfer device according to some embodiments of the present disclosure. FIG. 5 is a schematic partial perspective view illustrating a rotation unit of a roll transfer device according to some embodiments of the present disclosure.

Referring to FIGS. 1 to 6, the rotation unit 120 may be provided in pairs disposed on both sides of the roll core 11 in the first direction D1.

Each of the pair of rotation units 120 may linearly move in the first direction D1. That is, the rotation unit 120 may move forward toward the roll core 11 or may retreat in the opposite direction.

The rotation unit 120 may move forward toward the roll core 11 for position alignment in the first direction D1 of the roll core 11.

The rotation unit 120 may be retreated in a direction opposite to the roll core 11 along the first direction D1 so that the roll 10 in which a unique identification number is completely recognized may move in the second direction D2. When the rotation unit 120 is retreated, the controller may move the pair of holding units 112 in the second direction D2 to transfer the roll 10 to the stacker crane.

The rotation unit 120 may linearly move in the first direction D1 and align the position of the roll 10 in the first direction D1 while being inserted into the roll core 11 seated on the holding unit 110.

The rotation unit 120 may include one or more keys 123.

The key 123 may be coupled to one or more key grooves 12 formed in the roll core 11.

The rotation unit 120 may rotate in a state of being inserted into the roll core 11. The key 123 is coupled to the key groove 12 by the rotation of the rotation unit 120, so that the roll 10 may also rotate together.

The rotation unit 120 may include a rod 121, a pad 122, a first driving member 124 and a second driving member 125.

The rod 121 may have a shape extended in the first direction D1 toward the roll core 11. The rod 121 may be provided to be rotatable.

The rod 121 may be connected to the first driving member 124. The rod 121 may linearly move in the first direction D1 by the first driving member 124.

The rod 121 may be connected to the second driving member 125. A shaft included in the rod 121 may be connected to the second driving member 125 by a pulley or the like. The rod 121 may be rotated by receiving power from the second driving member 125.

The pad 122 may be integrally formed with the rod 121. The pad 122 may have a circular shape corresponding to the roll core 11. The pad 122 may be provided on one side of the rod 121 toward the roll core 11 along the first direction D1.

The pad 122 may move forward in the first direction D1 by the linear movement of the rod 121 and inserted into the roll core 11.

The pad 122 may be retreated in the first direction D1 by the linear movement of the rod 121 and thus may be detached from the roll core 11.

The pad 122 may include a key 123.

One or more keys 123 may be disposed on an outer circumferential surface of the pad 122 along a circumferential direction. The key 123 may be coupled to one or more key grooves 12 by the rotation of the rod 121 in a state that the pad 122 is inserted into the roll core 11.

In a state that the key 123 is coupled to the key groove 12, the roll 10 may be rotated by the rotation of the rod 121.

The first driving member 124 is provided to linearly move the rod 121. The first driving member 124 may be connected to the controller.

For example, the first driving member 124 may have a shape of an air cylinder.

The first driving member 124 may move the rod 121 forward or backward along the first direction D1. As the rod 121 moves forward or backward through the first driving member 124, the pad 122 may be inserted into the roll core 11 or may be detached from the roll core 11.

Through the linear movement of the rod 121 by the first driving member 124, the pad 122 may be inserted into the roll core 11 to pressurize the roll core 11, thereby aligning the position of the roll 10.

That is, the rods 121 disposed on both sides of the roll core 11 along the first direction D1 move forward toward the roll core 11 and are inserted into the roll core 11 to pressurize the roll core, so that the position of the roll 10 may be aligned in the first direction D1.

The second driving member 124 is provided to rotate the rod 121. The second driving member 125 may be connected to the controller.

For example, the second driving member 125 may have a motor shape.

The second driving member 125 may rotate the rod 121 in a state that the rod 121 moves forward in the first direction D1 by the first driving member 124 and the pad 122 is inserted into the roll core 11.

The second driving member 125 may rotate the rod 121 so that the key 123 disposed on the pad 122 inserted into the roll core 11 may be coupled to the key groove 12.

The second driving member 125 may continuously rotate the rod 121 in a state that the key 123 is coupled to the key groove 12, whereby the roll 10 may be also rotated together.

The roll transfer apparatus 100 according to some embodiments of the present disclosure may further include a barcode reader that recognizes a unique identification code for the material wound on the roll 10. The barcode reader may be connected to the controller. The barcode reader may be disposed on the worktable 130. The barcode reader may be disposed above the rotation unit 120.

The barcode reader may recognize a unique identification number at a predetermined position by the rotation of the roll 10. That is, in a state that the position of the roll 10 is aligned by the linear movement of the rod 121 by the first driving member 124, the roll 10 is also rotated by the rotation of the rod 121 by the second driving member 125 so that the barcode reader may recognize the unique identification number constantly at a specific position.

This makes it possible to conveniently recognize the unique identification code for the material wound on the roll 10 even though the roll 10 carried and stocked in the roll transfer device 100 is not stored in place.

The roll transfer device 100 according to some embodiments of the present disclosure may further include a worktable 130.

The worktable 130 may be provided in pairs spaced apart from each other along the first direction D1. The worktable 130 may be extended in the second direction D2. The holding unit 110 may be disposed on each of the pair of worktable 130.

The worktable 130 may include a linear motion (LM) guide provided at a position adjacent to the roll core 11 along the first direction D1 on its upper surface.

The worktable 130 may include an LM motor 131, an LM guide rail 132 and an LM block 133.

The LM motor 131 may be disposed on one side opposite to the rotation unit 120 along the second direction D1 on the upper surface of the worktable 130. The LM motor 131 may be connected to the controller.

The LM guide rail 132 may be disposed in pairs connected to the LM motor 11 and extended in the second direction D2.

The LM block 133 may be disposed on the LM guide rail 132 and moved along the LM guide rail 132 in the second direction D2. The LM blocks 133 may be also provided in pairs disposed on the pair of LM guide rails 132, respectively.

The support panel 120 of the holding unit 110 may be connected to the LM block 133. The roll 10 in which the unique identification number is recognized through the LM block 133 coupled to the support panel 120 may be transferred to the stacker crane along the second direction D2.

That is, as the roll 10 is rotated through the second driving member 125 in a state that the position of the roll 10 is aligned by the first driving member 124, when the unique identification number of the roll 10 is recognized, the controller actuates the LM motor 131 so that the LM block 133 moves along the second direction D2, whereby the roll 10 seated on the holding unit 110 may be transferred in the second direction D2.

At this time, in a state that the controller stops the rotation of the rod 121 by stopping the actuation of the second driving member 125 before moving the LM block 133, the controller actuates the first driving member 124 to retreat the rod 121 towards the opposite side of the roll core 11 along the first direction D1, thereby actuating the LM motor 131 in a state that the pad 122 is detached from the roll core 11.

When the transfer of the roll 10 through the movement of the LM block 133 is completed, the controller actuates the LM motor 131 again to move the LM block 133 toward the rotation unit 120 along the second direction D2 so that the LM block 133 may be returned to its original position. By the return of the LM block 133, the pair of holding units 110 may be also returned to its original position for the following transfer process.

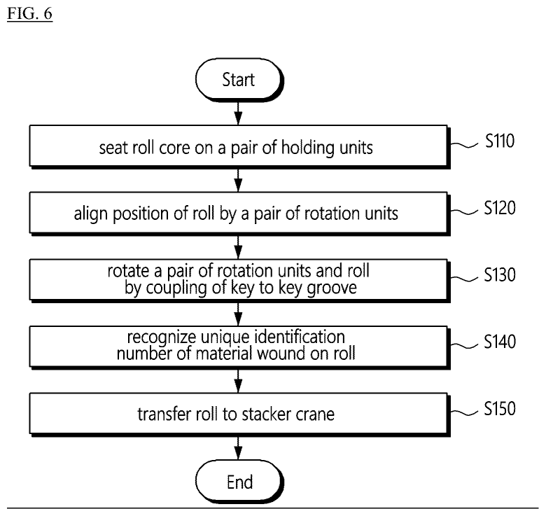

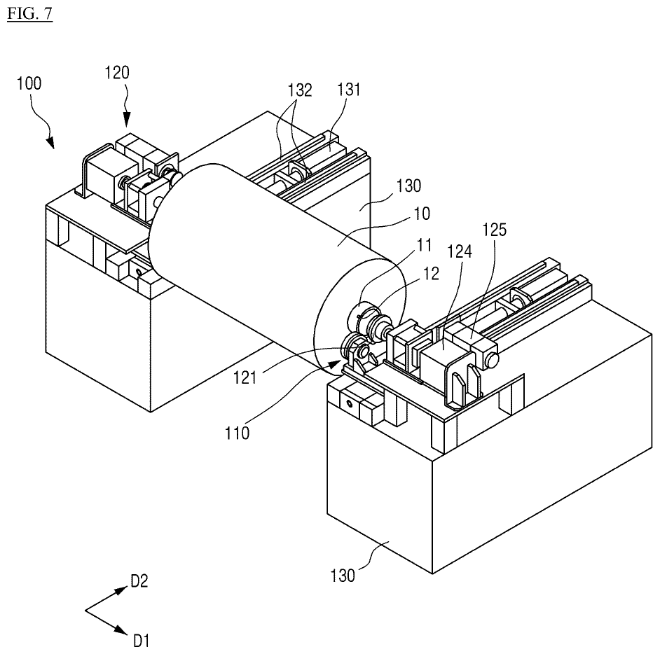

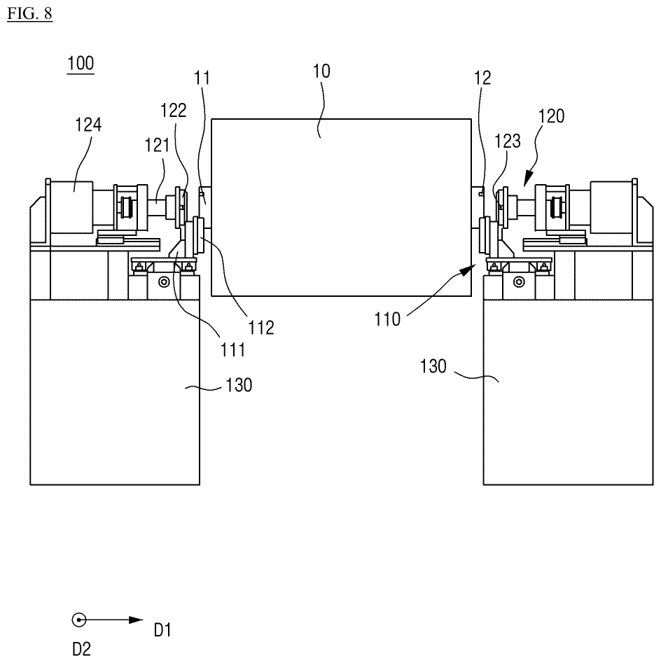

FIG. 6 is a flow chart illustrating a roll transfer method according to some embodiments of the present disclosure. FIG. 7 is a schematic perspective view illustrating a state that a roll core is seated on a holding unit of a roll transfer device to describe a roll transfer method according to some embodiments of the present disclosure. FIG. 8 is a schematic cross-sectional view illustrating a state that a roll core is seated on a holding unit of a roll transfer device to describe a roll transfer method according to some embodiments of the present disclosure.

Referring to FIGS. 6 to 8, the roll core 11 of the roll 10 carried and stocked by an unmanned transport vehicle or a forklift is seated on an upper portion of the pair of holding units (S110).

The roll 10 which is carried and stocked is disposed between the pair of holding units 110 disposed to be spaced apart from each other in the first direction D1 to face each other.

Subsequently, the roll core 11 is seated on the upper portion of the pair of holding units 110.

In a state that the roll core 11 is seated on the pair of holding rollers 112 of the holding unit 110, the controller actuates the first driving member 124 so that the rod 121 may move forward toward the roll core 11 along the first direction D1.

As each rod 121 of the pair of rotation units 120 disposed on both sides of the roll core 11 along the first direction D1 continues to move forward, the pad 122 is inserted into the roll core 11.

After the pad 122 is inserted into the roll core 11, the rod 121 and the pad 122 of each of the pair of rotation units 120 pressurize the role core 11 by continuous actuation of the first driving member 124 so that the position of the roll 10 is aligned along the first direction D1 (S120).

When the position alignment of the roll 10 is completed, the controller stops the actuation of the first driving member 124.

Subsequently, the controller actuates the second driving member 125 to rotate the rod 121.

In a state that the pad 122 is inserted into the roll core 11, one or more keys 123 provided on the pad 122 that rotates integrally with the rod 121 are coupled to one or more key grooves 12.

In a state that the key 123 is coupled to the key groove 12, the rod 121 of each of the pair of rotation units 120 is continuously rotated, so that the pair of rotation units 120 and the roll 10 are rotated together (S130).

In this case, the controller also actuates the driving means of each of the pair of holding units 110 simultaneously with the actuation of the second driving member 125 to rotate the pair of holding rollers 112, thereby supporting the rotation of the roll core 11 according to the rotation of the roll 10.

When the roll core 11 is also rotated in accordance with the continuous rotation of the roll 10 and then disposed at a specific position, the barcode reader recognizes a unique identification number provided at the specific position to recognize the material wound on the roll 10, and transmits a recognition signal to the controller (S140).

Subsequently, the controller stops the actuation of the second driving member 125 and the driving means of the pair of holding units 110.

The controller actuates the first driving member 124 again so that the rod 121 of each of the pair of rotation units 120 is retreated toward the opposite side of the roll core 11 along the first direction D1, whereby the pad 122 is detached from the roll core 11 and the rod 121 returns to its original position.

When the return of the rod 121 of the pair of rotation units 120 is completed, the controller actuates the LM motor 131 so that the LM block 133 moves along the second direction D2.

As the pair of holding units 110 move in the second direction D2, the roll 10 seated on the pair of holding units 110 may also move in the second direction D2 and then may be transferred to the stacker crane (S150).

When the transfer of the roll 10 through the movement of the LM block 133 is completed, the controller actuates the LM motor 131 again so that the LM block 133 may return to its original position.

That is, the LM block 133 may move toward the rotation unit 120 along the second direction D2, so that the pair of holding units 110 may also return to their original positions for the next transfer process.

As described above, in the roll transfer device and method according to some embodiments of the present disclosure, the position of the roll 10 may be quickly and accurately aligned through the rotation unit 120, and at the same time the unique identification code for the wound material may be easily recognized, whereby productivity may be improved, and the time and manpower required for the position alignment of the roll 10 and the recognition of the unique identification code may be shortened.

Although the embodiments of the present disclosure have been described with reference to the accompanying drawings, it will be apparent to those skilled in the art that the present disclosure may be embodied in other specific forms without departing from the technical spirits and essential characteristics of the present disclosure. Thus, the above-described embodiments are to be considered in all respects as illustrative and not restrictive.

What is claimed is:

1. A roll transfer device comprising:
a pair of holding units disposed to be spaced apart from each other in a first direction, supporting a roll core seated thereon; and
a pair of rotation units disposed on both sides of the roll core along the first direction,
wherein the pair of rotation units linearly move in the first direction and are inserted into the roll core seated on the holding unit to align a position of the roll,
include one or more keys coupled to one or more key grooves formed in the roll core, and
are rotated in a state that they are inserted into the roll core, so that the key is coupled to the key groove, thereby rotating the roll.

2. The roll transfer device of claim 1, wherein the holding unit includes
a support panel,
a pair of holding rollers disposed on the support panel to rotatably support the roll core, and
a driving means provided to rotate the pair of holding rollers.

3. The roll transfer device of claim 2, wherein the holding unit further includes a detection sensor for detecting the seating of the roll core.

4. The roll transfer device of claim 1, further comprising a pair of worktables spaced apart from each other in the first direction and extended in a second direction, on which the pair of holding units are respectively disposed.

5. The roll transfer device of claim 4, wherein the worktable includes
an LM motor disposed on one side of an upper surface,
an LM guide rail connected to the LM motor and extended in the second direction, and
an LM block moving along the LM guide rail in the second direction.

6. The roll transfer device of claim 5, wherein a support panel of the holding unit is connected to the LM block to transfer the roll in the second direction.

7. The roll transfer device of claim 1, wherein the rotation unit includes
a rod extended in the first direction toward the roll core,
a pad provided on one side of the rod toward the roll core, including the key,
a first driving member provided to linearly move the rod in the first direction, and
a second driving member provided to rotate the rod.

8. The roll transfer device of claim 7, wherein the pad aligns the position of the roll by pressurizing the roll core while being inserted into the roll core through linear movement of the rod by the first driving member.

9. The roll transfer device of claim 8, wherein the key is coupled to the key groove by the rotation of the rod by the second driving member so that the roll rotates together with the rod in a state that the positon of the roll is aligned.

10. The roll transfer device of claim 9, further comprising a barcode reader that recognizes a unique identification code for a material wound on the roll through the rotation of the roll.

11. A roll transfer device comprising:
a pair of holding units disposed to be spaced apart from each other in a first direction, supporting a roll core seated thereon; and
a pair of rotation units disposed on both sides of the roll core along the first direction,
wherein the rotation unit includes
a rod extended in the first direction toward the roll core,
a pad provided on one side of the rod toward the roll core, including a key coupled to a key groove formed in the roll core,
a first driving member provided to linearly move the rod in the first direction, and
a second driving member provided to rotate the rod.

12. The roll transfer device of claim 11, wherein the pad aligns the position of the roll by pressurizing the roll core while being inserted into the roll core through linear movement of the rod by the first driving member.

13. The roll transfer device of claim 12, wherein the key is coupled to the key groove by the rotation of the rod by the second driving member so that the roll rotates together with the rod in a state that the positon of the roll is aligned.

14. The roll transfer device of claim 13, further comprising a barcode reader that recognizes a unique identification code for a material wound on the roll through the rotation of the roll.

15. The roll transfer device of claim 11, wherein the holding unit includes
a support panel,
a pair of holding rollers disposed on the support panel to rotatably support the roll core,
a driving means provided to rotate the pair of holding rollers, and
a detection sensor for detecting the seating of the roll core.

16. The roll transfer device of claim 11, further comprising a pair of worktables spaced apart from each other in the first direction and extended in a second direction, on which the pair of holding units are respectively disposed.

17. The roll transfer device of claim 16, wherein the worktable includes
an LM motor disposed on one side of an upper surface,
an LM guide rail connected to the LM motor and extended in the second direction, and
an LM block connected with the support panel, moving along the LM guide rail in the second direction, and
the roll is transferred in the second direction.

18. A roll transfer method comprising:
seating a roll core on a pair of holding units at a position between the pair of holding units spaced apart from each other in a first direction to face each other by an unmanned transport vehicle or a forklift;
aligning a position of the roll along the first direction by the pair of rotation units disposed on both sides of the roll core;
coupling one or more keys provided in the pair of rotation units to one or more key grooves formed in the roll core by rotating the pair of rotation units in a state that the rotation units are inserted into the roll core, and thus rotating the roll together with the pair of rotation units;
recognizing a unique identification number for a material wound on the roll by a barcode reader; and
transferring the roll to a stacker crane by moving the pair of holding units in a second direction.

19. The roll transfer method of claim 18, wherein the rotation unit includes a rod extended in the first direction toward the roll core, a pad provided on one side of the rod toward the roll core, including the key, a first driving member provided to linearly move the rod in the first direction, and a second driving member provided to rotate the rod,
the pad aligns the position of the roll along the first direction by pressurizing the roll core while being inserted into the roll core through linear movement of the rod by the first driving member, and
the key is coupled to the key groove by the rotation of the rod by the second driving member so that the roll rotates together with the rod in a state that the positon of the roll is aligned.

20. The roll transfer method of claim 18, wherein the holding unit includes a support panel, a pair of holding rollers disposed on the support panel to rotatably support the roll core, a driving means provided to rotate the pair of holding rollers, and a detection sensor for detecting the seating of the roll core, and
transfers the roll by moving in the second direction in a state that the holding unit is disposed on a pair of worktables spaced apart from each other in the first direction and extended in the second direction.
